(19) United States
(12) Patent Application Publication
(10) Pub. No.: US 2020/0116670 A1
(43) Pub. Date: Apr. 16, 2020

(54) ELECTROPHORESIS METHOD WITH VARYING ELECTRICAL FIELD

(71) Applicant: GENETIC MICRODEVICES LIMITED, KlNGSTON UPON THAMES (GB)

(72) Inventor: DIMITRIOS SIDERIS, RICHMOND (GB)

(21) Appl. No.: 16/616,288

(22) PCT Filed: Jun. 13, 2018
(86) PCT No.: PCT/GB2018/051609

§ 371 Date: Nov. 22, 2019

(30) Foreign Application Priority Data
Jun. 13, 2017 (GB) 1709387.3

(51) Int. Cl. G01N 27/447

(52) U.S. Cl. CPC G01N 27/44713; G01N 27/44726

(57) ABSTRACT

The invention provides an electrophoresis method for detecting an analyte in a sample, the method comprising providing the sample and an agent that specifically binds the analyte, combined in a fluid medium in a separation channel; applying an electric field along the separation channel, the electric field having a field profile, and thereby causing bound and unbound analyte and/or agent to move relative to the fluid; varying the applied electric field so as to adjust the field profile relative to the separation channel, thereby causing the bound analyte and the unbound analyte to concentrate at locations apart from one another in the fluid under the combined influences of an electric force due to the electric field and a hydrodynamic force due to the fluid.

### FIELD

The present invention relates to electrophoresis methods for detecting an analyte in a sample.

Electrophoresis techniques are well known and are used to separate objects according to their electrical and hydrodynamic properties. Other separation techniques include the use of centrifugal spectrometers as described in EP1455949.

In conventional electrophoresis, a constant and uniform electric field is applied to move objects through a fluid or a sieving matrix. As they move through this material, the objects experience forces which depend on their shape and size (e.g. hydrodynamic forces) and/or on their affinity for the material (e.g. chemical attraction/repulsion forces), and an electric force due to the applied field, which depends on their apparent charge. As a result of the different forces experienced by each object type, the objects move with different terminal velocities depending on their individual characteristics and thus they separate into “bands”.

Current electrophoresis methods for detecting analytes in a sample, such as western blotting (sometimes referred to as a protein immunoblot), are slow and time consuming, involve extensive sample preparation using a number of different chemicals and buffers and tend to provide only an indication of the presence of an analyte and basic information about its size and/or charge properties. In western blotting, gel electrophoresis (generally using polyacrylamide gel) is performed to separate denatured proteins by their size (or native proteins by their 3-D structure). The gel and the sample buffer generally contain sodium dodecyl sulphate (SDS) to give all proteins in the sample a uniform negative charge, which aids electrophoresis. This is known as SDS-polyacrylamide gel electrophoresis (SDS-PAGE). Before separation on the gel, protein samples are generally boiled to denature the proteins present. After separation on the electrophoresis gel, the proteins are blotted onto a membrane (generally nitrocellulose or polyvinylidene fluoride is used). The unoccupied binding sites on the membranes are then blocked with a protein solution (e.g. milk) to prevent non-specific antibody binding in the next stage. The membrane is washed and then incubated with antibodies that specifically bind to the protein of interest. A further washing step and antibody incubation step with an antibody that recognises the first antibody and is attached to a detectable tag is often then carried out to enhance the signal. This also simplifies and reduces the cost of the reagents as the primary antibody does not need to be tagged. The detectable moiety (often ³²P or an enzyme that can be detected by its digestion of a substrate causing a colour change) is then detected to provide the final result: often a poor resolution band at an approximate size (calculated using a size marker protein sample prepared on the gel in parallel). Without the electrophoresis step there would likely be a great deal of antibody cross-reactivity, which would render the assay relatively useless.

As explained above, in preparing the sample for a western blot, the protein is often denatured so the native configuration of the protein is lost. This has the disadvantage of requiring the use of binding agents (antibodies) directed to linear epitopes (a binding site recognised by an antibody). Such antibodies to linear epitopes can be far more limited in range and research-diagnostic value. Thus, antibodies raised to the native protein through immunization, for example, may not be useful on western blots for many proteins. Also, the multitude of steps and reagents necessary mean that it can take many hours to complete a western blot and the results can be very variable. The harsh processes that the protein sample is subject to may also damage other aspects of their structure that may be of research or diagnostic value, such as post translational modifications (e.g. glycosylation sites).

Other related immunoassay (assays utilising antibodies) techniques include dot blot analysis, quantitative dot blot, immunohistochemistry, immunocytochemistry (where antibodies are used to detect proteins in tissues and cells by immunostaining) and enzyme-linked immunosorbent assay (ELISA).

In ELISA, an electrophoresis step is not involved. The samples used in ELISA are typically less contaminated with other non-protein matter (e.g. DNA, lipids etc) to enable a cleaner result. In ELISA, a protein sample is placed in a plastic well usually on a multi-well culture plate. The protein naturally adheres to the plastic after a short incubation step. The same blocking, washing and antibody incubation and washing steps as described above for the western blot are then performed. The detectable moiety on the secondary antibody in ELISA is an enzyme that changes the colour of a substrate when present. Thus, each well is incubated with the substrate after all the washing and incubation steps are completed to reveal a signal in each well containing the protein of interest (by the secondary signal of the primary and secondary antibodies being present). This is a useful assay for detecting the presence of an analyte in a sample but is limited in terms of the information that is retrievable. An advantage of ELISA over other immunoassays is that the immobilised proteins remain more or less in their native tertiary form, which can essential for naturally produced antibodies to bind.

Various devices have been produced to enable automation and better standardisation of immunoassays, such as capillary nano-immunoassay devices reviewed in Chen et al (2015) J Transl Med 13:182. This seeks to address the problems inherent with profiling protein samples with typical immunoassays such as limitations in clinical sample size, poor reproducibility, unreliable quantitation and lack of assay robustness.

The capillary nano-immunoassay system is a significant advance from classical immunoassay techniques but it still suffers from the drawback of having to perform multiple incubation and wash steps as the basic process is the same as with a western blot. Further, expensive and complicated machinery is required to enable the capillary action to function as the various solutions must be passed through the small capillary where the separation and blotting takes place. These assays are faster than classical immunoassays but they still take many hours.

Another problem with all forms of immunoassay is that visualisation of the signal and thus identification of the analyte is by indirect means. As explained above, this involves two antibodies, a primary antibody that specifically recognises the analyte in question and a secondary antibody that recognises the primary antibody and is attached to a detectably moiety, such as a fluorescent tag or enzyme. Thus, a signal from the detectable moiety actually only indicates that the secondary antibody is present and doesn't directly detect the analyte. This signal could conceivably come from bound and un-bound secondary antibody. Of course, blocking and washing procedures in the process minimise non-specific binding but this can never be completely removed. Also, the indirect means by which the analyte is detected inherently leads to a multi-step process over many hours.

The listing or discussion of an apparently prior-published document in this specification should not necessarily be taken as an acknowledgement that the document is part of the state of the art or is common general knowledge.

The present invention provides an electrophoresis method for detecting an analyte in a sample, the method comprising providing the sample and an agent that specifically binds the analyte, combined in a fluid medium in a separation channel; applying an electric field along the separation channel, the electric field having a field profile, and thereby causing bound and unbound analyte and/or agent to move relative to the fluid; varying the applied electric field so as to adjust the field profile relative to the separation channel, thereby causing the bound analyte and the unbound analyte to concentrate at locations apart from one another in the fluid under the combined influences of an electric force due to the electric field and a hydrodynamic force due to the fluid. In an embodiment, the fluid medium may be the sample.

The concept of field shifting analysis for separation of objects by electrophoresis was proposed by one of the present inventors, wherein, rather than being constant, the applied electric field has a time dependent field gradient. Examples of electrophoresis devices which use this concept are described in WO 2006/070176 and WO 2012/153108, the entire content of which are hereby incorporated by reference. In comparison to conventional techniques, field shifting analysis offers enormous potential in terms of analytical and processing capabilities, offering several orders of magnitude faster and more sensitive separations. Field shifting techniques have not however previously been applied to the detection of analytes bound to binding agents as presently claimed. A skilled person would not have thought to do this as conventional means for performing such assays require multiple steps of electrophoresis, blotting/sequestration, washing and multiple binding agent incubation and signal amplification stages. The present inventors have surprisingly found that binding agent and bound analyte remain associated on an electrophoresis medium and only a simple single step is required to provide accurate identification and quantification. This can be enhanced yet further by using a tagged binding agent. It is also surprising that the binding analysis can actually be carried out in the electrophoresis medium without disassociation. Indeed, as indicated above, in certain embodiments a specific electrophoresis medium is not required as the present methods can be carried out directly on analyte-containing samples (such as biological fluids, e.g. blood, saliva, environmental samples etc.) without the need for any additional special medium or processing.

Field shifting devices usually employ a network of electrodes to apply a suitable time dependent electric field gradient for the separation and manipulation of analytes and other materials in a microfluidic environment. For example, the microfluidic environment may involve a planar separation channel in or on a glass device, with cross sectional dimensions of the order of 0.1 to several hundred pm and a length of at least 500 μm. Further examples of different electrophoresis devices can be found in U.S. Pat. No. 6,277,258 and US-A-2002/0070113.

The present invention enables direct visualisation of antibody/analyte binding so that the actual presence of the analyte can be verified and properly quantified. This is particularly useful when only small amounts of analyte are present in the sample. The present invention can provide an immunoassay that allows for almost immediate identification of a desired analyte with a high level of sensitivity. The nature of the devices also allows for this method to be automated and performed on a high throughput manner that will provide powerful new techniques for carrying out diagnostic and forensic methods.

The present invention also provides a fast and simple process to detect analyte in a sample without the need to go through the time consuming, laborious and expensive blocking, washing and incubation steps inherent in other forms of electrophoresis such as western blotting and capillary immunoassays. Indeed, the application of the sample direct to the device as described herein enables extremely fast results without the need for any sample processing. It is envisaged that certain particularly viscous samples may require addition fluid to be added to enable the method of the invention to be carried out but this would be determined at point of use, as would be understood by a person of skill in the art.

The present invention allows for a direct single step analysis that can be carried out without the need for any sample processing. Therefore, the present invention allows visualisation of the analyte in minutes, which makes it an extremely useful tool for research, diagnostic and forensic purposes, for example.

It is envisaged that the method may involve the further step of detecting the analyte by its co-location with binding agent. The electrophoresis method of the invention simultaneously separates and concentrates analytes at certain locations according to, for example, their size and other properties (for example charge). It is possible to visualise this in the fluid medium almost immediately.

Therefore, the analyte may be identified by its co-location with the binding agent by virtue of the increased size of the combination of the analyte and the binding agent.

It is envisaged that the sample and the agent may be combined prior to contacting the fluid medium. Pre-mixing of the sample and the binding agent allows binding of the binding agent to the analyte prior to electrophoresis. This may provide an advantage in expediting detection of bound analyte in the separation channel. Further, this may enhance the binding of the binding agent to the analyte prior to electrophoresis, which may act to drive unbound analyte and binding agent apart.

Alternatively, the sample may be added to the separation channel pre-loaded with the fluid medium and binding agent. Thus, the binding of the binding agent to the analyte may happen in the separation channel either before or during electrophoresis. The order in which the sample, binding agent, fluid medium and any other appropriate buffer for example are mixed will depend in part on the nature of the sample and the binding agent. Indeed, the type of fluid used may also play a part. As would be understood by a person of skill in the art, if antibodies are used as the binding agent, the binding action of antibodies is so fast that it is unlikely that any reduction in binding would be seen if the sample and binding agent are combined in the separation channel. The sample, binding agent and fluid medium may be mixed in any order prior to or after addition to the separation channel.

In a yet further alternative, the binding agent may be added to the sample, which is then directly added to the separation channel without any further fluid medium. Thus, in this embodiment, the fluid medium is the sample. Alternatively, the sample may be added direct to the separation channel and then the binding agent added to the sample in the separation channel, again, without any further fluid medium. In this embodiment also, the fluid medium is the sample. It would be understood that in certain circumstances, for example when the sample is particularly viscous or low in volume, additional fluid medium may be added to the sample prior to loading or when loaded onto the separation channel.

It is envisaged that particular samples may be well suited to direct addition to the separation channel without additional fluid medium. For example, aqueous samples and/or samples where the analyte is not present in large concentrations may be preferentially added to the separation channel for electrophoresis without any additional fluid medium. This may be applicable for example to plasma, saliva, urine, water from environmental sources etc. It may be particularly advantageous to utilise direct electrophoresis of the sample where the analyte is in low concentration or very fast analysis in the field is required. This enables fast results with minimal sample preparation. It is surprising that this is possible as conventional wisdom dictates that specific buffers are required for electrophoresis. The present invention surprisingly provides an electrophoresis method that is more adaptable, flexible and powerful such that the requirements for specific buffers do not apply.

It is envisaged that while performing the method of the invention the change in concentration of the analyte at a location may be monitored over time. The concentration of the analyte at the location may be monitored continuously or at defined time intervals. Thus, the increase in signal at the particular location may be determined and plotted against time as a calibration step or indeed to provide information about the concentration of the analyte in the original sample. Thus, one can see the binding of the binding agent to the analyte in real time and derive useful diagnostic or analytical information from the sample. This real-time signal provides great advantages over other methods for detecting analytes in a sample.

By the term “analyte” we mean any entity whose detection is desired and for which a specific binding agent is available. It is preferred that the analyte comprises a biological cell (e.g. prokaryotic or eukaryotic cell) or a biological molecule, such as a protein a nucleic acid or other biological polymer. For example, the biological molecule may comprise peptides, deoxyribonucleic acid (DNA), ribonucleic acid (RNA), lipids, polysaccharides or modifications thereof. Exemplary modifications may include glycosylated polypeptides. The analyte may be a bacterial cell or a virus or a cancer cell.

By the term “agent” we intend any entity that has the capacity to recognise and bind to a specific target, such as a molecule or part thereof. By “bind” we mean any strong typically non-covalent interaction between molecules that is semi-permanent under non-reducing conditions. Such interactions are typically hydrogen bonding, ionic associations and/or via Van der Waals forces as would be well understood by a person of skill in the art.

The “analyte” and “agent” and any other molecules in the sample may be collectively referred to herein as “objects” to be separated.

It is preferred that the agent comprises an antibody or antigen binding fragment or derivative thereof. The term “immunoglobulin(s)” is used herein interchangeably with the term “antibody” or “antibodies”. By “antibody, antigen binding fragments or derivatives thereof” we include the meaning that the antibodies comprise an antibody or antigen binding fragment thereof such a Fab-like molecules; Fv molecules; single-chain Fv (ScFv) molecules where the VH and VL partner domains are linked via a flexible oligopeptide and single domain antibodies (dAbs) comprising isolated V domains, but it may also be any other ligand which exhibits the preferential binding characteristic mentioned herein. The antibodies may be chimeric. It is expected that the antibodies will be monoclonal but they may be polyclonal. By “antigen” we include the meaning of any compound that contains an epitope that is specifically recognised by an immunoglobulin. Thus, the analyte may be described as an antigen when the agent is an antibody. It is envisaged that the epitope that the antibody binds is to be found on the analyte.

In an alternative embodiment, the agent may be a nucleic acid molecule. This will be particularly appropriate when the analyte is a oligomeric nucleic acid molecule (i.e. a short nucleic acid molecule). Thus, the agent and analyte in such circumstances would be expected to have complementary nucleic acid sequences to allow specific hybridisation (i.e binding) with one another. By “complementary” we intend to mean the capacity for precise pairing of two monomeric subunits regardless of where in the agent oligomeric compound or analyte nucleic acid the two are located. For example, if a monomeric subunit at a certain position of an oligomeric compound is capable of hydrogen bonding with a monomeric subunit at a certain position of a target nucleic acid, then the position of hydrogen bonding between the oligomeric compound and the analyte nucleic acid is considered to be a complementary position. The oligomeric compound and the target nucleic acid are “substantially complementary” to each other when a sufficient number of complementary positions in each molecule are occupied by monomeric subunits that can hydrogen bond with each other. Thus, the term “substantially complementary” is used to indicate a sufficient degree of precise pairing over a sufficient number of monomeric subunits such that stable and specific binding occurs between the agent oligomeric compound and an analyte nucleic acid. Generally, an oligomeric compound agent will be “antisense” to an analyte (target) nucleic acid when, written in the 5′ to 3′ direction, it comprises the reverse complement of the corresponding region of the target nucleic acid. It is understood in the art that the sequence of the oligomeric compound need not be 100% complementary to that of its target nucleic acid to be specifically hybridizable. Moreover, an oligomeric compound may hybridize over one or more segments such that intervening or adjacent segments are not involved in the hybridization (e.g., a bulge, a loop structure or a hairpin structure). In some embodiments of the invention, the oligomeric compounds comprise at least 50%, at least 60%, at least 70%, at least 75%, at least 80%, or at least 85% sequence complementarity to a target region within the target nucleic acid. In other embodiments of the invention, the oligomeric compounds comprise at least 90% sequence complementarity to a target region within the target nucleic acid. In other embodiments of the invention, the oligomeric compounds comprise at least 95% or at least 99% sequence complementarity to a target region within the target nucleic acid. For example, an oligomeric compound in which 18 of 20 nucleobases of the oligomeric compound are complementary to a target sequence would represent 90 percent complementarity. In this example, the remaining non-complementary nucleobases may be clustered or interspersed with complementary nucleobases and need not be contiguous to each other or to complementary nucleobases. As such, an oligomeric compound which is 18 nucleobases in length having four non-complementary nucleobases which are flanked by two regions of complete complementarity with the target nucleic acid would have 77.8% overall complementarity with the target nucleic acid and would thus fall within the scope of the present invention. Percent complementarity of an oligomeric compound with a region of a target nucleic acid can be determined routinely using BLAST programs (basic local alignment search tools) and PowerBLAST programs known in the art (Altschul et al., J. Mol. Biol., 1990, 215, 403-410; Zhang and Madden, Genome Res., 1997, 7, 649-656).

It is preferred that the agent may be labelled with a detectable moiety. The labelling of the binding agent with the detectable moiety would generally be a permanent covalent interaction between the agent and the moiety, possibly via a linking molecule, as would be understood by a person of skill in the art. By “detectable moiety” we mean any reporter molecule or atom that has properties that allow it to be directly or in-directly visualised or detected in some way so as its presence can be determined. Examples of suitable detectable moieties for use in the methods of the invention include a fluorescent molecule (e.g. Alexa-488), photochromic compounds (e.g. diarylethene), an enzyme, a fluorogen (e.g. Y-FAST), a radioactive label (e.g. ³²P or ³H), a DNA probe, a heavy atom (e.g. Au) or an electrochemiluminescent tag. The fluorescent tag may be any molecule that emits fluorescent light either naturally or when exposed to radiation such as visible or ultra-violet light. Examples of suitable fluorescent tags include ethidium bromide; fluorescein; rhodamine; green, yellow, red or cyan fluorescent protein; an Alexa Fluor dye (e.g. Alexa -488, -350, -405, -430, -500, -514, -532, -546, -555, -568, -594, -610, -633, -635, -647, -660, -680, -700, -750, or -790) or any other commercially available fluorescent tag as would be well understood by a person of skill in the art.

Alternatively, or additionally, label free methods may be used for the detection of the analyte and/or binding agent. Any suitable label free detection method may be used. For example, UV absorption may be used to detect the analyte and binding agent. The present method is particularly suited to UV absorption due to concentration of the sample at a position in the fluid. The signal may be concentrated by a thousand fold thus lending itself to UV adsorption. Generally, the use of UV adsorption is limited with peptide detection as the signal detected can be quite low compared with fluorescence detection, potentially 1000× lower. The local concentration of the sample achieved with the present method can overcome the limitations of UV adsorption and enable sensitive UV absorption. It is envisaged that when detecting a protein, a wavelength of between 150 and 350 nm, for example between 180 and 300 nm, between 200 and 280 nm or between 210 and 220 nm may be used. It is envisaged that a wavelength of approximately 215 nm will be sufficient to detect the backbone of the protein and therefore would be appropriate to detect all proteins. A wavelength of around 280 nm may also be appropriate as this is where certain amino acids, such as tryptophan absorb UV. Further, wavelengths of approximately 255 nm may be appropriate when detecting DNA or other nucleic acids such as RNA, as would be understood by a person of skill in the art. Indeed any wavelength at which the analyte and/or binding agent absorb UV would be appropriate, as would be understood by a person of skill in the art. However, at these low wavelengths absorption of the UV radiation by the materials used to make the separation channel and the other components of the device used to perform the method of the invention may interfere with the result. For example, materials such as standard glass and PMMA (Perspex) will absorb the radiation. Therefore, to address this problem, it is envisaged that materials such as quartz, fused silica or Cyclic Olefin Copolymer (COC) plastics may be used to manufacture the separation channel and other parts of the device as necessary, as would be understood by a person of skill in the art. An alternative label free method of detecting the analyte and binding agent that may be employed in the present methods is Laser Induced Fluorescence (LIF). By LIF we do not mean just mean simple fluorescence detection using fluorescent labels, where the excitation light source is a laser but we also include the inducement of intrinsic fluorescence by the use of a strong excitation source, i.e. a laser, as would be understood by a person of skill in the art. Other suitable label free detection methods are also envisaged.

It is envisaged that the sample may be a sample of biological fluid. For example the sample may be a blood, plasma, serum, semen, saliva, sweat, lymph, cerebrospinal fluid, faeces, peritoneal fluid, sputum, or mucous sample or any other sample or swab taken from the human or animal body for testing. The sample may be an environmental sample or any other sample that contains an analyte to be detected, for example a sample from a crime scene. The sample may be used untreated or it may be treated to purify, concentrate or disinfect it to enhance safety or improve detection of the analyte using the methods of the invention. For example, then sample may be heat treated or filtered or dried, as would be deemed appropriate by a person of skill in the art. The sample may also act as the “fluid medium” as herein defined without the need for addition of any further fluid.

By “separation channel” we mean any enclosed space in which the fluid medium, analyte and agent may reside when they are subjected to electrophoresis according to the invention. It could be a typical channel used for electrophoresis or a plurality thereof. It will be understood that the nature of the separating channel may vary depending on the type of application of the present invention. In general, the separating channel may represent any volume in which fluids or objects of interest may be accommodated (and/or may move through) during analysis, whether being physically constrained by a channel or other physical entity or not. For example, where the separating channel comprises one or more channels, each one may or may not be physically delimited: the separating channel could for instance encompass one or more paths (which may be thought of as ‘imaginary’ or ‘virtual’ channels) taken by analytes in ‘free flow’ electrophoresis devices or “slab-gel” techniques. The embodiments described below refer primarily to separating channels in the form of physically-defined channels for separation of objects, although it will be understood that this is not intended to be limiting. Thus, then separation channel may be a well, a tray, a capillary tube or any other suitable container in which the electrophoresis may take place, as would be understood by a person of skill in the art. The channel may be open or closed and may be loaded from any conceivable angle or means according to the typical methods known in the art. It is preferred that the separation channel is contained on a chip such as the devices described in WO 2006/070176 or WO 2012/153108, the teaching of which are incorporated herein by reference.

By “concentrate at locations” we intend that the analyte and agent migrate to a position or phase in the electric field where they reach equilibrium according to the hydrodynamic forces exerted by the fluid and the electric force exerted by the electric field. This position may correspond to a particular location within the medium and separation channel but this may also move relative to the medium and separation channel according to the field and hydrodynamic forces. Thus, instances of bound analyte and agent at different locations in the fluid/field will migrate to the same or substantially the same location thus resulting in a concentrating effect such that their concentration at that particular location increases as they move from elsewhere. This enhances the signal and provides a fast way to determine the presence or otherwise of the analyte. If unbound analyte initially resides at a location where the bound analyte will eventually reside, it will initially move away from that location until it meets a binding agent, then, upon binding it will migrate back to its original location.

It will be appreciated that the term “fluid” is used here to describe any appropriate electrophoresis medium. For example, the fluid could be a liquid, a gel, a sieving matrix or any other material that can generate frictional or hydrodynamic forces on a moving object. For example the fluid may be polyacrylamide or agarose or any other suitable fluid as would be understood by a person of skill in the art. The fluid may simply be the sample (for example the sample as found in nature) without any processing or addition of further fluid. This is particularly envisaged for samples comprising an aqueous fluid containing the analyte.

In an embodiment of the method of the present invention the electric field may vary with respect to the separation channel along at least a portion of the field profile. Further, or alternatively, at least a portion of the electric field profile may have a gradient which is non-zero.

By varying the applied electric field relative to the separation channel from substantially the outset of the electrophoresis process (as opposed to after the analytes are concentrated), the objects can be separated without the need for fluid flow through the separation channel. The applied electric field establishes a time-varying field profile, which achieves electrophoretic separation by forcing the particles to move through the fluid, which can therefore be stationary itself. It should be noted that the electric field is non-constant (with respect to the channel) along at least a portion of the field profile. In other words a (non-zero) time-varying electric field gradient is applied. As a result, the objects separate into moving bands which do not widen with time.

This does away with the need for complicated and expensive pumping equipment and eliminates problems associated with the parabolic velocity front encountered in conventional electrophoresis systems. Further, the technique lends itself well to the use of a gel or sieving matrix as the separation fluid, since no fluid flow is required. The particular electric field and its variation will depend on the types of object to be separated and the fluid used as the separation medium. Preferably however, the electric field is varied in such a way that the field profile moves relative to the separation channel.

The field profile could change in shape and/or intensity as it moves, but further preferably, the field profile remains unchanged as it moves relative to the separation channel (i.e. maintains its shape and intensity). Typically, it is convenient for the objects to be separated along the channel and so it is preferable that the electric field is varied in such a way that the electric field profile translates along the separation channel.

Depending on the objects to be separated, it may be beneficial to maintain some degree of fluid flow through the channel. However, as already described it is usually advantageous if fluid flow can be eliminated and so it is preferable that the fluid and the separation channel are substantially stationary with respect to one another.

The particular shape of the applied electric field will be selected according to the desired output from the device. However, typically the electric field profile is shaped such that the net force experienced by each object, resulting from the combination of the electric force exerted by the field and the hydrodynamic force exerted by the fluid, is such that the objects concentrate at particular locations and remain at such locations over time. Preferably, the field profile is such that the objects concentrate with increasing clarity and eventually acquires a finite point within the separation channel, and diffusion of the objects around each point is bound or confined so that the objects remain at the same place and do not diffuse over time as long as the experimental conditions remain the same. Hereinafter this is referred to as “bound diffusion”.

Once the objects are separated and concentrated into singularities, the electric field could be removed. However, it is advantageous to continue the application of the field and vary it such that, once the objects have separated, each object moves with a non-zero terminal velocity relative to the separation channel. This maintains high resolution since the continuously moving objects do not diffuse over time.

In conventional electrophoretic separations, different bands move with different terminal velocities. In other words as they move through the buffer or gel, they get further and further apart from each other. Assuming that the increase in relative distance is faster than the band widening due to diffusion, the resolution of electrophoresis increases with larger separation lengths (i.e. longer separation channels). However, the signals weaken with time due to the diffusion and very large separation channels are impractical. Therefore in practice “band loss” can occur when bands reach the end of the channel. In contrast, in the present invention, it is preferable that the objects move with substantially equal terminal velocity. Therefore the separation efficiency does not depend on the length of the separation channel but instead on the characteristics of the applied time varying electric field and the characteristics of the separation buffer. Preferably, the terminal velocity of each object is essentially the same and thus the spacing between each is maintained. Further preferably, the terminal velocity is constant over time.

The electric field could be linear or non-linear. It is advantageous if at least a portion of the electric field is monotonic with respect to distance along the channel. This facilitates the separation of sample molecules and confinement of band diffusion. Preferably, the electric field should be continuous along a portion of the field profile. It should be further noted that the field profile can move in either direction along the separation channel.

Details of appropriate electric field forms and devices for obtaining the appropriate fields and which may be used in the methods of the present invention may be found in WO 2006/070176 or WO 2012/153108, the teaching of which are incorporated herein by reference.

In any embodiment of the present invention, it is intended that multiple analytes may be detected simultaneously in a single assay, for example in a single separation channel. Thus, several different immunoassays (for example when antibodies or fragments or derivatives thereof are the binding agent) may be performed in a single channel. It is envisaged that when assaying different analytes in the same sample, different detectable moieties for each specific binding agent may be used. Alternatively, or additionally, when analytes with different physicochemical properties (such as charge or mass) are detected they would be expected to locate to different locations within the field and therefore be discriminated accordingly. The field shifting properties described herein will allow the operator to focus in and out of different analyte locations as part of an analysis. This focusing may be referred to as selective assembly concentration as the field may be used to selectively concentrate and focus in on a particular selected assembly. Of course, particularly when the process is automated and controlled by a computer it would be possible to simultaneously selectively concentrate assemblies of different analytes as the field will allow. Indeed, even if different analytes locate to similar locations they could be discriminated according to the high accuracy of the selective assembly concentration and/or the detectable moiety used to identify their location. When certain colours are used for example, a co-location of different colours might be expected to provide a different colour readout demonstrating that the target analytes have similar physicochemical properties. For example, a blue and a yellow signal co-locating will provide a green signal. Multiple assays may be performed in multiple channels on a single device allowing for very complex analysis of diverse samples. The analysis of multiple analytes simultaneously may be useful when performing broad proteome or transcriptome analysis of a sample, for example. This type of assay could be useful also for studying protein-protein interactions in a sample as combined proteins will locate apart from single proteins in the field. Thus, the detected analyte may not only be a single protein or other macromolecule (for example, nucleic acid, polysaccharide, phospholipid etc) but also a complex of proteins or other molecules. As would be understood by a person of skill in the art, there are many examples of assays where such a complex high throughput assay may be useful. In the environmental field, samples could be screened simultaneously for multiple toxic compounds or pathogens and a result obtained almost immediately. Real-time analysis of expressed proteins in a cell exposed to certain stimuli could be performed to provide fast and accurate biochemical analysis. Indeed, such analysis may be performed in real time with the cell being exposed to the tested stimuli in the fluid medium. The present invention allows for complex patterns of analytes to be simultaneously detected to provide fast readouts, which would be particularly helpful in the diagnostic, toxicology and forensic fields. Many applications could be conceived of where it would be beneficial to screen for multiple analytes as described herein. For example, the present invention could be used to screen drug targets against compound libraries to identify suitable drug candidates or to identify suitable aptamers.

Advantageously, the method of the invention may further comprise the step of modifying the electric field to: (i) adjust spacing between the unbound and bound analyte; (i) adjust the relative positioning of the unbound and bound analyte; (iii) adjust the resolution of signal of the unbound and bound analyte; (iv) adjust the intensity of signal from the unbound and bound analyte; and/or (v) adjust the concentration of the unbound and bound analyte at a particular location within the fluid. This can be achieved by changing the shape of the electric field profile, its intensity or its position along the separation channel, for example. This can be used to view a different range of objects, move an object to a particular point along the separation channel or adjust the number of objects that are resolvable, for example. In particular, the electric field may be modified by changes to its time-dependence and/or its intensity. It will be understood by a person of skill in the art that the objections will generally be visualised as peaks on a fluorescence chart and this different peaks may be identified for each analyte and agent, alone or combined. The peaks will increase in height as the object concentrates at a particular location and decrease in height as an object moves away from a particular location.

In an embodiment, the method of the invention may further comprise the step of extracting a sample of interest from the separation channel after the analyte and agent have located. The extraction could be by adjusting the field such that the sample moves to an exit port, or it could be by direct physical lifting from the appropriate location in the separation channel, as would be understood by a person of skill in the art.

Advantageously, the method of the invention may further comprise the step of oscillating the electric field, causing the motion of the analyte and/or agent to reverse in direction, the analyte and/or agent thus moving back and forth along the separation channel. This allows each object to be imaged or otherwise detected repeatedly and thus can increase the sensitivity of the device for low concentration components. This can also be achieved by causing the objects to travel in circuits around a closed loop separation channel. Indeed, this can be used to focus in on particular analytes and agents to direct analysis to particular analytes in turn. Thus, one can change the electric field profile during or after the initial electrophoresis to modify which signal is identified and to look at different analytes of interest. This flexible and powerful approach is not possible with any other form of electrophoresis assay for detecting analytes in a sample. This selective assembly concentration effect is described in the examples with reference to a particular example. The device carrying out the method of the invention can me moved from a “monitoring” mode where all peaks are identified to a “discovery” mode where particular peaks are focused in on, as required.

Thus, in an embodiment of the present methods the separation channel may be a closed loop and in this case it is preferable that the applied electric field is periodic around the loop.

In a further embodiment, of the present electrophoresis method the electric field may be applied by an electric field applying assembly and an electrical interface region may be provided between the separation channel and the electric field applying assembly, the electrical interface region arranged such that the electric field is applied to the electrical interface region by the electric field applying assembly at a location spaced from the separation channel; wherein the electrical interface region comprises at least an ionically conductive material arranged adjacent to and in contact with the separation channel; such that the electric field applied by the electric field applying assembly is smoothed by the electrical interface region so that the electric field profile established within the separation channel is substantially continuous.

The present embodiment therefore allows for smoothing of the applied electric field by converting the discrete electric field obtained from the electric field applying assembly (e.g. an electrode array) into a substantially continuous field in the separation channel. A ‘discrete’ electric field is one with a field profile which is non-continuous, e.g. including gaps or sudden jumps or drops in magnitude, such as may be observed in a “step-profile” shaped field. For example, a discrete electric field may arise from multiple point voltage sources, each spaced from the next along the periphery of the separation channel (e.g. in the case of a channel, along its path). By a ‘substantially continuous’ electric field it is meant an electric field which is smoother than the discrete electric field. For instance, in the above example, the value of the smoothed electric field preferably changes gradually in the interval between the location of one point voltage source and the next, from a value corresponding to that established by the first point source to a value corresponding to that established by the second. More generally, the substantially continuous field may be smoothly interpolated between the applied discrete values. However, depending on the degree of smoothing applied, the continuous field may depart to an extent from a perfect linear gradient or curve and could still include some discontinuities (albeit smaller in magnitude than those of the discrete field).

The field shaping is achieved by providing an electric interface region between the separation channel and the electric field applying assembly which has suitable electrical and geometrical properties, whereby the electric field applying assembly is spaced away from the separation channel by the electrical interface region. In particular, the field smoothing is performed, at least in part, by means of ionic current transport within an ionically conductive material forming part (or all) of the electrical interface region and arranged adjacent to and in contact with the separation channel. This arrangement has the substantial advantage that any electrolysis takes place either within the electric interface region or at the electrodes (or other voltage source) and not in the separation channel. In this way, there is no disruption to the environment within the separation channel itself.

It should be noted that the electrical interface region does not need to be provided along the whole periphery of the separation channel, but could extend along a portion of the separation channel only. For example, the electrical interface region does not need to be provided along the whole length of the channel, but could extend along a portion of the channel only.

By ‘adjacent to and in contact with’ the separation channel it is meant that the ionically conductive material is provided in direct electrical contact with the separation channel, without any other material type inbetween. The electrical interface region can be made up of a single component (the ionically conductive material), or more than one component arranged in series (and in electrical contact with one another) between the electrical field applying assembly and the separation channel. In one example, as will be described in more detail below, the electrical interface region may comprise an ionically conductive material adjacent to the separation channel and a non-ionically conductive material, for instance an electrically resistive material, the non-ionically conductive material being provided between the electric field applying assembly and the ionically conductive material. However, in other advantageous embodiments, the electrical interface region consists of ionically conductive material. In other words, the electrical interface region is formed wholly of ionically conductive material. For instance, the aforementioned (single) ionically conductive material directly contacting the separation channel may extend continuously between the separation channel and the electrical field applying assembly. Alternatively, more than one ionically conducting component, or a mixture of ionically and non-ionically conducting components may be deployed in series between the separation channel and the electrical field applying assembly to form the electrical interface region.

The term ‘ionically conductive’ means that the material conducts electricity by movement of ions. There may or may not also be movement of electrons or holes through the material. In addition to the portion of the electrical interface region contacting the separation channel, the separation channel is preferably also ionically conducting and not primarily electrically conducting. For example, the separation channel may be a channel filled with an ionic conductor such an aqueous buffer, as will be described in more detail below.

It is desirable that the conductivity/resistivity of the one or more components making up the electrical interface region (and particularly that of the ionically conductive material) should be configured to “match” that of the separation channel. By “matched”, it is not required that the or each component of the electrical interface region should have equal or at least similar ionic conductivity as that of the separation channel, although this is preferred. What is necessary is that the relative conductivities/resistivities are balanced to avoid the electrical current being conducted preferentially by either the electrical interface region or by the separation channel. If the conductivity of the electrical interface region is too high or too low, the field shape may not form as desired in the separation channel. This is because, if the relative conductivities of the fluid and the ionically conductive material were markedly different, then, in accordance with Ohm's law, all the current arising from the applied voltages could pass only through the electrical interface region or only through the separating channel. This would significantly alter the field smoothing effect, leading to over-smoothing or under-smoothing of the field. In particular, if the relative conductivity of the electrical interface region is too low, the electric field obtained in the separation channel may be damped, i.e. appear much lower than the intended field applied at the electrodes, because the power is essentially lost in the electrical interface region.

To achieve matching, it is not essential that the resistivities/conductivities of the component(s) forming the electrical interface region and of the separation channel are identical and indeed this is extremely difficult to achieve. However, in preferred configurations, the conductivities/resistivities are of the same order of magnitude. In particularly preferred embodiments, the ratio of the resitivities/conductivities of the component(s) making up the electrical interface region to that of the separating channel (or vice versa) is between 1:100 and 1:1, preferably between 1:50 and 1:1, more preferably between 1:10 and 1:1.

Advantageously, the ionically conductive material contacting the separation channel is impervious to gases (produced, for example by electrolysis at the electrodes) thereby preventing them from reaching the separating channel. Alternatively, the geometry can be arranged to guide any gas bubbles away from the separation channel. The ionically conductive material preferably prevents any analytes to be separated inside the separation channel from reaching the electrodes. For example, any pores in the material are preferably too small to permit passage of the objects therethrough. This helps to retain the objects within the separation channel and avoids sample loss.

In certain preferred examples, the electrical interface region has a thin, ‘membrane’-like or ‘film’-like geometry whereby its width (i.e. the distance between the electric field applying assembly and the separation channel) is at least greater than its thickness in a direction perpendicular to both said distance and the separation channel (e.g. the long axis of a channel). More preferably, the distance between the separation channel and the electric field applying assembly is at least twice the thickness of the electrical interface region, more preferably at least 5 times the thickness of the electrical interface region, further preferably at least 5 times, still preferably at least 10 times, most preferably at least 100 times.

The preferred membrane-like geometry effectively averages out the voltages obtained between the electrodes. This ‘spreads out’ each point voltage along the periphery of the separation channel (with relatively little voltage dispersion in any other direction), thereby enabling smoothing of the discrete applied field from the electric field applying assembly primarily along the periphery of the separating channel. By keeping the material thin, the voltage can be arranged to be substantially constant in the material's thickness direction, avoiding the establishment of transverse electric fields in the separation channel. However, this can alternatively be achieved by arranging the electric field applying assembly to apply a discrete electric field which does not vary in the thickness direction of the electrical interface region (e.g. by the use of electrodes which contact the material across its full thickness).

Alongside the smoothing of the electric field, at the same time the electrical interface region keeps the microfluidic environment inside the separation channel separate from the electrodes so as not to disrupt the separation or manipulation process.

Preferably, the separating channel is provided in or on a substrate and the electric interface region substantially fills a cavity in or on the substrate. The substrate itself can be conveniently fabricated using selected microfabrication techniques.

Preferably, the depth of the separating channel is approximately equal to or greater than the thickness of the interface region in the same direction. In particular, the depth of the separating channel is preferably between 1 and 5 times greater, preferably between 1.5 and 3 times greater, still preferably around 2 times greater than the thickness of the material. The inventors have found that this proportion enables formation of a separating channel in the form of a channel by means of capillary forces acting on the electrical interface region material in fluid form, as will be described below.

In preferred embodiments, the distance between the location at which the discrete electric field is applied and the separating channel is between 0.1 and 8 mm, preferably between 0.5 and 2.5 mm. Preferably, the thickness of the electrical interface region is between 0.1 and 100 μm, preferably between 20 and 40 μm. Preferably, the depth (height) of the separating channel is between 0.1 to 500 μm, preferably between 10 and 100 μm.

In certain circumstances, it is desirable that the cavity in the substrate be provided with at least one pillar to provide support and prevent collapse of the top piece of the substrate. Pillars may also be deployed to alter the electrical properties of the interface, as mentioned below. Furthermore, pillars provide additional surface area to help retain the material(s) in the electrical interface region.

In preferred embodiments, the separating channel can follow any desirable path. For example, the channel may be rectilinear or may be in the form of a closed loop. The closed loop configuration provides several advantages over open loop designs such as a rectilinear channel. Firstly, closed loop channels avoid edge effects whereby the electric field obtained inside the channel at either end of the channel, deviate from the desired levels. For example, in a linear channel, a section in the middle of the channel will typically be presented with applied voltage sources either side of the section along the channel, the voltage obtained in the section being an average of the two voltages. A section near an end of the channel, however, does not “see” voltage sources provided on both sides, but only on the side towards the other end of the channel. This means that there is an asymmetric averaging, which causes a distortion in the field inside the section near the end of the channel. Secondly, when applying time-shifting electric fields to open loop channels, regions may occur where the field varies very little and the electric current direction remains essentially unchanged. This can lead to severe localised ion depletion in the ionically conductive material comprised in the electrical interface region. As a result, the desired field shape in the channel is lost since the effects of ion depletion tend to counteract the applied field. In contrast, in a closed loop channel, such as a circular arrangement, a propagating electrical “wave” (i.e. a shaped, non-uniform electric field profile) can be configured to travel around the loop. This ‘sweeps’ ions in the ionically conductive material around the loop, continuously replenishing any ion denuded regions and carries away ions from correspondingly over concentrated areas, so that the field in the channel remains smooth and stable. Thirdly, when an open loop channel is utilised, the effective operational length of the device is dictated by the physical length of the channel. In closed loop systems, there is no beginning or end to the main channel and so the device has essentially an infinite operational length.

Preferably, the electric field applying assembly comprises a plurality of electrodes in electrical contact with the electrical interface region and the electric field applying assembly further comprises a controller adapted to apply a voltage to each electrode in order to obtain a desired field profile.

The electrodes are preferably spaced from one another along a direction conforming to a periphery of the separating channel. For example, it is preferable that the electrodes are spaced along a direction conforming to the path of the channel.

In preferred embodiments, the plurality of electrodes is arranged along one side of the separating channel. Advantageously, the electric field applying assembly may further comprise a second plurality of electrodes arranged along the opposite side of the separating channel from the first plurality of electrodes, thereby forming pairs of electrodes on opposite sides of the separating channel and wherein a voltage can be applied to each electrode of the pair. In some preferred embodiments, substantially the same voltage is applied to both electrodes in each pair. However in other cases different voltages may be applied to each electrode in the pair, e.g. in order to counteract differential velocity effects due to curvature of the separating channel (as described in WO2006/070176), or to laterally manipulate the field within the volume.

The device may further comprise an electric field measuring assembly adapted to measure the electric field in the separating channel, (and/or along the electrical interface material); and wherein the controller is advantageously adapted to vary the applied discrete electric field based on the measured electric field. Accordingly, apart from ‘write’ electrodes applying the discrete electric field, ‘read’ electrodes may be used for measuring and controlling the applied field. The ‘read’ electrodes may contact the separating channel directly or may measure the established electric field via a portion of electrical interface region (which may or may not be the electrical interface region located between the separating channel and the electric field applying assembly). For example, the electric field measuring assembly may preferably comprise a plurality of electrodes in electrical contact with the electrical interface region, the plurality of electrodes of the electric field measuring assembly preferably being arranged on the opposite side of the separating channel from the electric field applying assembly. In alternative advantageous embodiments, the device may use the same electrode(s) as write or read electrode(s), switching between the two modes as required. For example, the controller could be adapted to stop supplying voltage to each electrode for a short period at regular intervals, and to instead read the local field instantaneously, before resuming voltage supply.

The substrate can be provided with holes (also referred to as wells or well nodes) in connection with the cavity (and the interface region filling the cavity) and with a surface of the substrate, for accommodating an electrode in use. The holes can be filled with ionically conducting fluid, such as an aqueous buffer, a thixtropic gel or a viscous gel, and arranged such that electrodes are dipped in the ionically conducting fluid. Advantageously, this configuration provides escape points for the gas products of electrolysis. Furthermore, providing the substrate with holes filled with an ionic conductor allows for a sufficient ion reservoir size to mitigate ion depletion in the ionically conductive material comprised in the electrical interface region. As an alternative to dipped electrodes such as those described above, conducting electrodes (e.g. formed of a metal film) may be deposited on the substrate, leading to one or more connector(s) on the device for integrating with an electric field control system. These electrodes would be in contact with the interface material and vents could be provided for the escape of electrolysis gases.

Advantageously, the electric field applying assembly used in the methods of the invention further comprises connecting arms, such as fluidic arms arranged to electrically connect each electrode to the electrical interface region. For example, the above-mentioned wells can be connected to a cavity filled with the electrical interface region via such connection arms. The use of fluidic arms in the electric field applying assembly provides increased design flexibility. For instance, the holes may be drilled in a top piece of the substrate and have any configuration as found convenient for the application, while the fluidic arms act as conductors for applying the voltages to the electrical interface region. By careful design of each arm's dimensions (and hence the electrical resistance it presents), the voltage level presented to the material can be controlled. Each connection arm preferably connects a single one of the electrodes to the electrical interface region.

The holes in the substrate may be periodically spaced along a single line which follows the periphery of the separating channel. However, this is not essential and each hole could be positioned at a different distance from the separating channel. In one example, the holes may be staggered with respect to the periphery of the separating channel in order to maximise the number of holes that can be provided along the periphery of the separating channel. The different positions of the holes (and, hence, the electrodes they contain in use) could be negated by design of fluidic arms of the electric field applying assembly between the hole and the material. However, in other examples, the varying distances could be made use of in the establishment of the voltage variation required to create an electric field along the periphery of the separating channel.

If the separating channel is in the form of an open loop (e.g. a channel having at least two distinct “ends”—whether defined physically or not), the electric field applying assembly may be configured to counter field edge effects. For example, in the case of a linear channel, two additional electrodes may be arranged to provide an extra voltage at each end of the channel. Preferably, these electrodes are inserted in well nodes on the channel, wherein the well nodes can also serve as inlets and/or outlets for the channel.

As mentioned above, the electrical interface region may comprise more than one component and in one preferred embodiment comprises a non-ionically conductive material in addition to the ionically conductive material, such that the ionically conductive material is located between the non-ionically conductive material and the separating channel and the discrete electric field is applied by the electric field applying assembly to the non-ionically conductive material. For example, the non-ionically conductive material can be placed between the ionically conductive material and the electrodes. The non-ionically conductive material conducts primarily by means of electron (and/or hole) movement and may be, for example, a resistive polymer or a semiconductor such as silicon.

In such embodiments, preferably, the conductivity/resistivity of the non-ionically conductive material and the conductivity/resistivity of the ionically conductive material are matched. As described above in relation to the relative conductivities/resistivities of the separating channel and electrical interface region, in the present context the term “matched” does not mean that the conductivities/resistivities have to be equal, although it is preferred that they are at least similar. By “matching” the conductivities/resistivites of the two (or more) components of the electrical interface region, both conductivities/resistivites are taken into account along with the applied field parameters such that both the non-ionically conductive material and the ionically conductive material contribute to the smoothing of the discrete electric field. If, on the other hand, the relative conductivities of the two materials were markedly different, then in accordance with Ohm's law, all the current arising from the applied voltages could pass only through the ionically conductive material or only through the non-ionically conductive material. This would significantly alter the field smoothing effect, leading to over-smoothing or under-smoothing of the field and possibly field-shielding effects. Therefore, in preferred configurations, the conductivities/resistivities of the components are of the same order of magnitude. In particularly preferred embodiments, the ratio of the two materials' resitivities/conductivities is between 1:100 and 1:1, preferably between 1:50 and 1:1, more preferably between 1:10 and 1:1.

The same considerations apply to an electrical interface region comprising two or more ionically conductive components in series, or a mixture of ionically and non-ionically conductive components, in which case the conductivities/resistivities of each component are preferably “matched”.

Configurations including a non-ionically conductive material as part of the electrical interface region provide several advantages. In particular, they provide flexibility in the connectivity with the electric field applying assembly. For example, electrodes may be connected to a “dry” solid material (e.g. silicon) instead of being dipped in fluid-filled wells as described above. This can result in a more coherent and sealed device. On the other hand, a disadvantage of such configurations is that the combination of an ionically conductive material (typically containing fluid) and a “dry”, non-ionically conductive material requires a fluid/solid interface which tends to give rise to electrolysis and evolution of gas bubbles. Accordingly, such configurations may require pores or wells located at this interface to act as exhausts for the gas bubbles.

The ionically conductive material may comprise for example a polymer. Advantageously, polymers may be easily introduced into a device according to the invention in liquid form and then polymerised in situ, either using a chemical initiator, or by thermal or photo-initiation, for example.

Preferably, the ionically conductive material is a porous material. A ‘porous’ material is one through which fluid can flow, for example though pores, channels or cavities of the material. A foam, a sponge or any other type of matrix-like or cellular material, are examples of porous materials. For example, the ionically conductive, porous material, may comprise a porous glass or a porous ceramic material.

Alternatively, the ionically conductive material may be a hydrogel. Hydrogels are a class of polymeric materials that are able to absorb aqueous solutions but do not dissolve in water. Hydrogels have many attributes which make them highly suitable for use in the presently-disclosed field shaping interface. In particular, they are porous, typically having pore sizes in the low nm range, which means that they are permeable to water molecules and small ions, but impervious to large analytes, including biomolecules such as proteins or DNA. Furthermore, hydrogels are typically impervious to gas bubbles, thereby preventing the gases formed by electrolysis at the electrodes from reaching the separating channel.

In a preferred embodiment, the resistivity of the electrical interface region is constant throughout its volume. Electrical homogeneity of the electrical interface region is generally desirable so as to achieve an isotropic field smoothing effect. Alternatively, in other embodiments, the resistivity may vary in at least one direction—for example, in a direction perpendicular to the periphery of the separating channel or the elongate direction of a channel. This could enable, for example, the application of different magnitude fields to a plurality of concentric circular channels each spaced by a portion of electric field interface region, whilst using a single electric field applying assembly.

Varying the resistivity of the electrical interface region can be achieved by altering the composition of the region material in one or more directions, e.g. through the use of multiple electrical interface components of different electrical properties. However, such alteration can be difficult in practice. Alternatively, the resistivity may be more easily varied by introducing pillars in the cavity and varying either their size or their density in one or more directions. This has the effect of removing conducting material and thus increasing the resistivity of the electrical interface region (or reducing it if the density of the pillars drops). Another example method for varying the resistivity of the electrical interface region is to vary the depth of the cavity.

The conductivity and relative thickness of the electrical interface region is preferably such that current flow is not excessive, in order to avoid Joule heating and excessive electrolysis at the regions where electrodes are applied.

In preferred embodiments, the substrate is electrically resistive or insulating. It may be desirable that the substrate is transparent to any one or more of: visible, infrared (IR) or ultraviolet (UV) radiation to allow for photo-patterning and photo-polymerisation of the electrical interface region material through the substrate, or to make the device suitable for use with optical detection techniques. However, in other cases the substrate need not be optically transparent.

Advantageously, a device for use with the present invention may allow for simultaneous analysis in the separating channel. For example, the volume may comprise a plurality of channels, each laterally spaced from the next by a region of electrical interface region, wherein the electric field applying assembly is configured to apply the discrete electric field to one portion of the electrical interface material, whereby the discrete electric field is smoothed by the electrical interface region such that a substantially continuous electric field is established in each of the plurality of channels. In a preferred configuration, the substantially continuous electric field established in each channel is substantially the same, although, as noted above, this is not essential. As an alternative, multiple channels could be stacked one on top of the other within the separating channel, each layer containing a channel separated by a layer of insulator, with the electrical interface material in contact with one or both sides of each of the channel layers. In another example, interface material layers and separating channel (channel) layers could be stacked one on top of the other, separated by insulating layers. Inlet channels for the introduction of samples to the separation channels within the separating channel could be embedded in the insulating layers.

In all of the embodiments, the means for applying the electric field could comprise any known field shaping apparatus, for example a variable resistance along the channel. Preferably however the means for applying an electric field comprise a plurality of electrodes spaced along the separation channel. This technique allows accurate and intricate shaping of the electric field and is conveniently controlled by varying the voltage applied to each electrode individually. It is preferable that the electrodes are spaced from the interior of the separation channel such that current is not conducted between the electrodes and the fluid. This avoids current flow through the fluid and thus prevents excessive joule heating which can lead to erratic behaviour in the system. Conveniently, the electrodes comprise conductive ink printed on or adjacent to the separation channel.

Advantageously, at least some of the plurality of electrodes are spaced from the interior of the separation channel by a layer of electrically resistive material. In this way, the electric field established inside the channel is smoother, less distorted by the local effects of the electrodes. The resistive material is preferably a semiconductor or doped semiconductor, most preferably doped silicon.

Preferably, the separation channel is a capillary. Such dimensions allow the electric field to be accurately controlled across the channel cross-section and lead to well defined points or peaks even with low concentration samples. In one preferred embodiment the separation channel is rectilinear. Alternatively, the separation channel could be in the form of a closed loop. This could be substantially circular or, preferably, have linear sections.

Conveniently, the separation channel is engraved in a substrate such as a glass plate. This provides a convenient way of implementing the device used to perform the invention on a very small scale. Preferably, the device is a microfluidic device.

Advantageously, the device used in the methods of the invention comprises a plurality of separation channels, each separation channel being provided with means for applying the electric field and a controller. The electric field applied to each separation channel could be chosen individually according to the objects to be separated in each channel. Preferably however the electric field applied to each separation channel is the same. Conveniently, the electric field applied to each separation channel is controlled by the same controller.

It is envisaged that the method of the present invention may be performed such that particular known analytes of interest are identified quickly according to their known parameters. This can be achieved by configuring the device on which the method is performed to preferentially separate out the analyte or analytes of interest according to their predicted size and other properties, as appropriate. When screening multiple analytes the device will be configured as appropriate as would be understood by a person of skill in the art. Thus, in the present method the electric field may be applied across a pre-set mobility window. This pre-set mobility window comprises a particular electric field that will target the analyte/binding agent(s) of interest such that it is separated out and concentrated away from other constituents in the sample. The targeting/focusing/selective assembly concentration on/at a particular analyte/binding agent can be performed immediately on starting electrophoresis or after separation has taken place, as described above. Thus, the signal from the analyte can be manipulated to target different entities.

The method may be performed on a device comprising the separation channel and wherein the separation channel is provided with at least one exit port for extraction of material from the separation channel. Accordingly, it is envisaged that the extracted material may be extracted to a sample collection well. Alternately or additionally, the extracted material may be extracted to a discard well, as required.

In a further embodiment of any method of this invention, the separation channel may further comprise a pH gradient. In this embodiment, the bound analyte and the unbound analyte will concentrate at locations apart from one another in the fluid under the further influence of their isoelectric properties due to the pH gradient. This is a development of the technique known as isoelectric focusing, which is a technique for separating different molecules by differences in their isoelectric point (pI). This is a type of zone electrophoresis, usually performed on proteins in a gel that takes advantage of the fact that overall charge on the molecule of interest is a function of the pH of its surroundings. In this embodiment, an ampholyte solution is typically added into immobilized pH gradient (IPG) gels. IPGs are the acrylamide gel matrix co-polymerized with the pH gradient, which result in completely stable gradients except the most alkaline (>12) pH values. The immobilized pH gradient is obtained by the continuous change in the ratio of Immobilines. An Immobiline is a weak acid or base defined by its pK value. A protein that is in a pH region below its isoelectric point (pI) will be positively charged and so will migrate towards the cathode (negatively charged electrode). As it migrates through a gradient of increasing pH, however, the protein's overall charge will decrease until the protein reaches the pH region that corresponds to its pI. At this point it has no net charge and so migration ceases (as there is no electrical attraction towards either electrode). As a result, the proteins become focused into sharp stationary bands with each protein positioned at a point in the pH gradient corresponding to its pI. The technique is capable of extremely high resolution with proteins differing by a single charge being fractionated into separate bands. Thus, this technique may be combined with the methods of the invention to further improve focusing of proteins of interest.

The present invention provides a diagnostic or forensic test comprising the methods described herein. Thus, the present invention may be used to identify analytes/biomarkers in samples where that analyte(s)/biomarker(s) is associated with a particular disease condition. The miniaturisation of the method and high-throughput potential allow for highly complex diagnostic tests to be set up to monitor the levels of many multiples of analytes/biomarkers. Further, in forensic studies, the present invention may be used to identify analytes that may be used to identify individuals or information regarding the origin of materials etc.

In order that the invention may be more clearly understood embodiments thereof will now be described by way of example with reference to the accompanying figures.

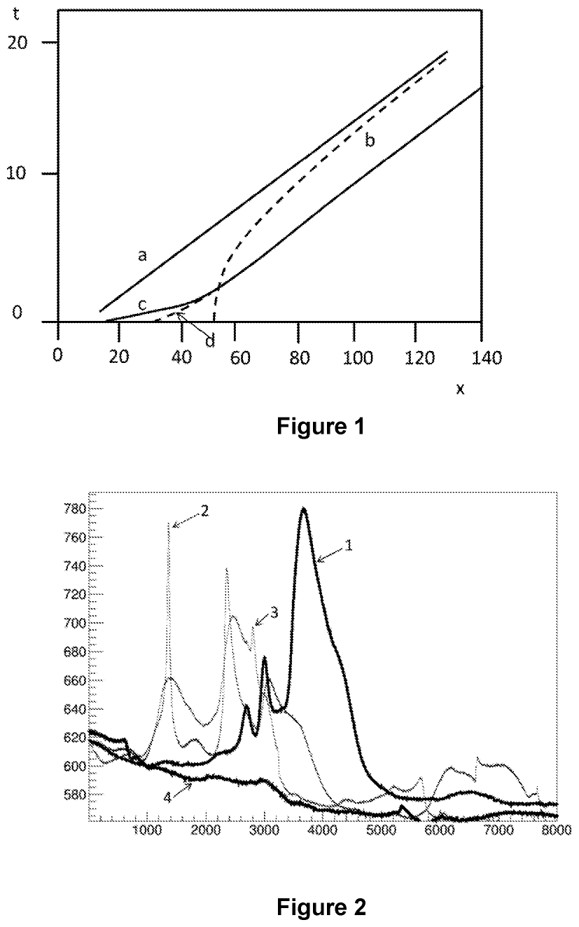

FIG. 1: Space-time trajectory of 4 molecules under the influence of the electric field as described in equation 2. Molecules a and b are identical, so are molecules c and d. But a is different to c (in terms of mass, charge and friction coefficient).

FIG. 2: CycloELISA detects Stat5 transcription factor through “on-chip” antibody (Alexa-488 tagged)+Antigen complex formation. Curve 1 is anti-STAT5 (Alexa-488 tagged)+STAT5. Curve 4 is Stat5 antigen alone (Ag only). Curve 2 is anti-STAT5 antibody alone (Alexa-488 tagged Ab only). Curve 3 is anti-cJUN (Alexa-488 tagged)+STAT5. The running conditions were: neutral pH, Stat5@10 ng/μL, Ab at 300 pg/μL. All lines are plotted with the same scaling.

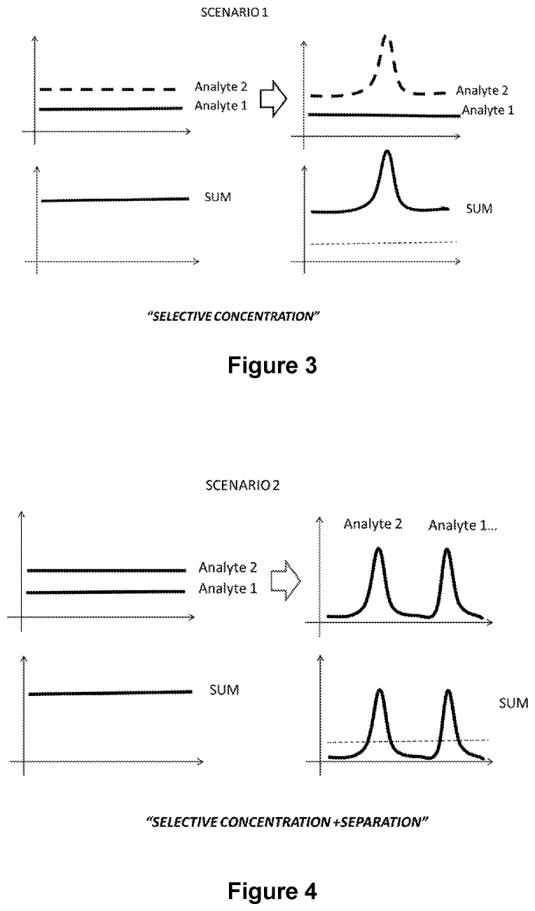

FIG. 3: Concentration of signal in method of the invention over the background.

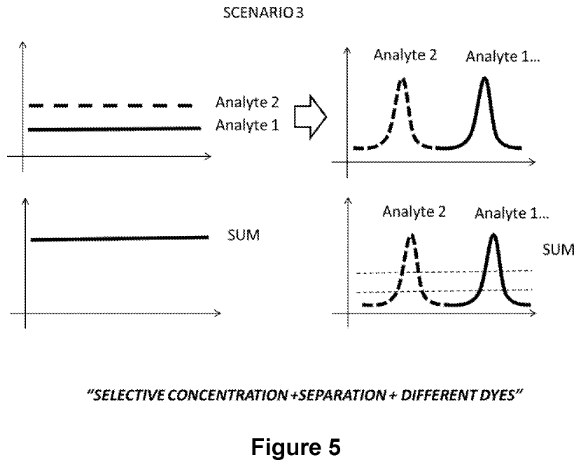

FIG. 4: Simultaneous concentration and separation of the signal over time.

FIG. 5: Separation using different labels with different optical characteristics on different antibodies to different analytes.

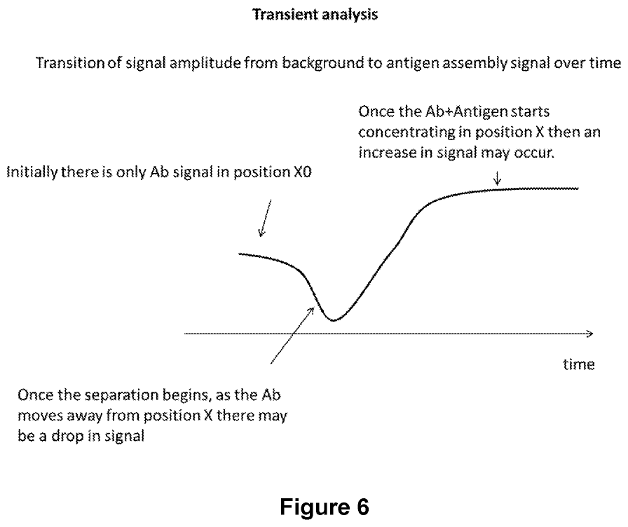

FIG. 6: Transient analysis of an antibody at point X over time before and after binding.

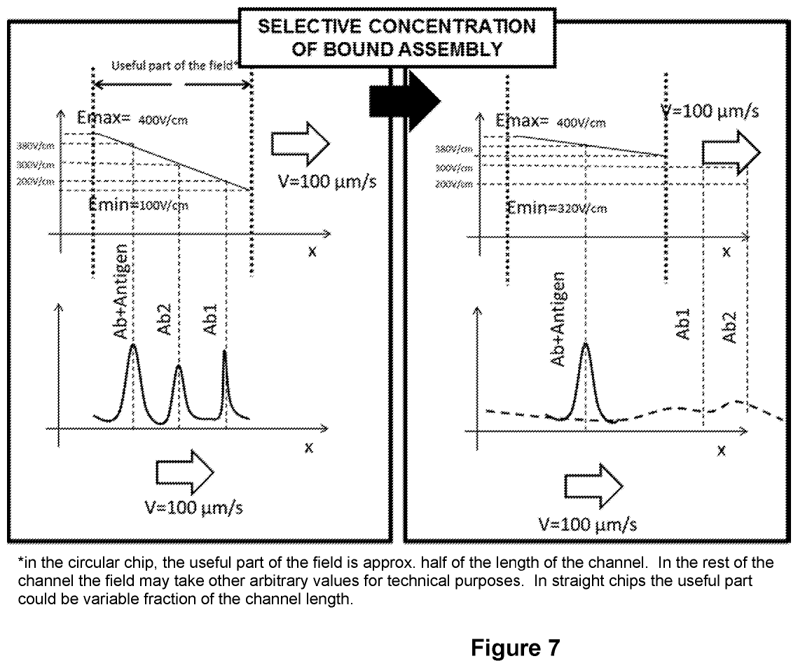

FIG. 7: Selective assembly concentration of an antibody/antigen complex. On the left of the figure Emax=400 V/cm and Emin=0 V/cm. The field is propagating with a speed of 100 μm/s. Selective assembly concentration is shown on the right of the figure where software is used to change Emin to 320 V/cm. The speed of the field remains constant and the field varies between 320-400 V/cm. The peaks on the chart represent antigen bound antibody assembly (Ab+Antigen) and then dimer (Ab2) and monomer (Ab1) of the same antibody, respectively.

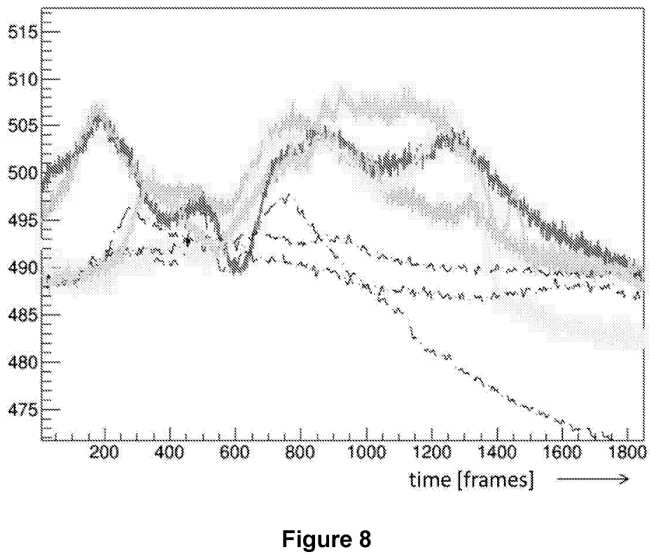

FIG. 8: Further demonstration runs of the invention using different running parameters: 4% linear polyacrylamide (LPA) sieving matrix and electric field speed 0.04 cm/s (other conditions the same). Dotted curves are Ab only, while the continuous curves are Ab+STAT5. As we can see, again the STAT5 peaks are clearly distinguished from the Ab only runs. In this configuration, the STAT5 peaks were observed in approximately 120 seconds.

### EXAMPLE 1

### Detection of Stat5 Transcription Factor Using Electrophoresis Method of the Invention

The present invention is exemplified herein using a device developed by the Applicant and named the CycloChip™. The CycloChip™ is a disposable plastic chip that comprises a separation channel and a plurality of electrodes as described herein. An exemplary immunoassay was performed and the term CycloELISA was used to indicate that the chip was being used for a different purpose than originally designed. Thus, effectively an immunoassay that uses antibodies to detect analyte (like an ELISA) but in a completely different way.

With the CycloChip™ (as explained above) once the analyte is introduced in the channel, a non-homogenous field in space and time, is applied in the channel. The field is essentially a shifting wave front that moves with velocity k through the separation channel. Like in electrophoresis, the analyte molecules start migrating in the channel under the influence of the variable field according to their mobility. However they now see a variable electric field.

The described field is of the polynomial form:

E(x,t)=Pⁿ(x−kt) (1)

where x is the longitudinal spatial displacement inside the channel, t is time and k is a real constant we call the “field parameter”. For simplicity let us now assume the simplest form of (1) for n=1:

E(x,t)=α(x−kt+c) (2)

where a and c are real constants. The force on a molecule of charge q will be simply qE. The frictional force on the same analyte molecule with a friction coefficient f will be:

F_{f}(x,t)=fv(x,t), f>0 (3)

in reality x is a function of time x=x(t) and therefore v(x,t)=v(t). From (2) and (3) we can form the following differential equation:

mv″(t)+fv′(t)−qav(t)+qak=0 (4)

which has the following solution:

$$x ( t ) = {x}_{0} + \frac{2 Am ( - 1 + {e}^{- \frac{( - f + \sqrt{{f}^{2} + q α m} ) t}{2 m}} )}{- f + \sqrt{{f}^{2} + 4 q α m}} + \frac{2 Bm ( - 1 + {e}^{- \frac{( f + \sqrt{{f}^{2} + q α m} ) t}{2 m}} )}{f + \sqrt{{f}^{2} + 4 q α m}} + kt \qquad ( 5 )$$

where A & B are functions of f, q, a, m. It turns out that in eq. (5) for large t (when analyte molecules have reached a terminal velocity) the exponentials disappear and the position of each analyte molecule is simply constant+kt. The constant depends on the analyte molecule characteristics and the field parameters and therefore all identical analyte molecules will co-migrate with velocity k. But different analyte molecules will migrate at different positions (because the constant is different) but still with the same velocity. This means that the above system will separate the molecules. In addition “run away” molecules which at some point happen to be away from their group, will experience a net force that tends to move them towards the group. Therefore the bands are coherent. FIG. 1 demonstrates the solution (5) for two pairs of analyte molecules. In each pair analyte molecules are identical, but between the pairs the analyte molecules are different. As can be seen the identical analyte molecules start from different positions and converge to the same space-time paths. But the paths for the two pairs of analyte molecules are different and parallel to each other. This means that the separation takes place and that identical analyte molecules which start at different positions tend to move in such a way as to co-migrate in the end.

In the present example the CycloELISA was loaded with a sample containing the Stat5 transcription factor. To this was added an antibody that specifically recognises Stat5, wherein the antibody was tagged with Alexa-488 (commercially available fluorescent tag). In the fluid medium complexes of Stat5 and Alexa-488 tagged antibody were formed and an electric field as described herein was applied.

The results of this test are provided in FIG. 2, which displays the fluorescence readout from the chip. Curve 1 is anti-STAT5 (Alexa-488 tagged)+STAT5, which as expected is the strongest signal at the largest size at frame 4000 (=400 s or 6.5 mins) corresponding to the stable antigen/antibody (Ab+Ag) complex. This shows that the antigen/antibody complex remained intact throughout electrophoresis. Curve 4 in FIG. 2 illustrates Stat5 antigen alone (Ag only) which should not fluoresce. Curve 2 is anti-STAT5 antibody alone (Alexa-488 tagged Ab only) which shows 2 signals corresponding to IgG monomers and dimers at lower molecular weight (MW). Curve 3 in FIG. 2 is anti-cJUN (Alexa-488 tagged)+STAT5 showing the specificity of the Ab+Ag interaction and apparent mass shift seen in the black curve. Anti-STAT5 and anti-cJUN IgG used here were the same isotype. The running conditions of the assay in FIG. 2 were neutral pH, Stat5@10 ng/μL, Ab at 300 pg/μL. All lines are plotted with the same scaling.

Thus, as demonstrated in FIG. 2 the present invention provides a powerful method to quickly identify analyte in a sample by directly visualising its interaction with the binding agent, without the need to perform time consuming laborious procedures typically associated with current methods such as ELISA.

The present invention allows for rapid separation of the signal from the background and concentration of the signal in the medium, not possible with ELISA.

### EXAMPLE 2

### Illustrative Visualisation of Analyte Using Methods of the Invention

FIG. 3 (Scenario 1) is an illustration of the kind of fluorescent signal that may be expected when using the methods of the invention to concentrate the signal over the background over time. In this situation a narrow field window is used between Emax and Emin to focus in on a particular analyte. Moving from left to right, FIG. 3 shows the signal from the Antibody/Antigen complex (Analyte 2) providing a peak at a particular point while the Antibody alone (Analyte 1) does not concentrate in that window. The lower charts are the sum of the signals. Thus, a strong signal is obtained over the background when binding with the fluorescently labelled antibody occurs. This can be used also to provide further qualitative and quantitative information by measuring the transient change in fluorescence amplitude over time as demonstrated in FIG. 6.

FIG. 4 (Scenario 2) is an illustration of the kind of fluorescent signal that may be expected when using the methods of the invention to simultaneously concentrate and separate positive signals from both bound and unbound antibody over the background over time. In this situation an extended field window is used between Emax and Emin to allow detection of both bound and unbound antibody (as they will have different sizes). Moving from left to right, FIG. 4 shows the signal from the Antibody/Antigen complex (Analyte 2) providing a peak at a particular point while the Antibody alone (Analyte 1) provides a peak at a different location due to the broader field window. The lower charts are the sum of the signals. Thus, a strong and discerning signal is obtained over the background when binding with the fluorescently labelled antibody occurs, which is separable from the signal from antibody alone.

FIG. 5 (Scenario 2) is an illustration of the kind of fluorescent signal that may be expected when using the methods of the invention to simultaneously concentrate and separate positive signals from two different antibodies labelled with different fluorescent labels over the background over time. This situation also uses an extended field window between Emax and Emin to allow detection of both antibodies (as they will have different sizes). Moving from left to right, FIG. 5 shows the signal from the a first antibody bound to a first analyte (Analyte 1) providing a peak at a particular point while the second antibody bound to a second analyte (Analyte 2) provides a peak at a different location due to the broader field window. The lower charts are the sum of the signals. This simultaneous analysis could be extended to many multiples of different antibodies to provide a very powerful technique of assaying multiple analytes quickly and in parallel. The antibodies may be run in the same channel and discerned by using different detection filters. This could all be automated with very large numbers of tags being measured.

FIG. 6 illustrates the transient analysis of a particular analyte over time at a single point. Initially, unbound antibody is detected, which migrates away from the pre-set mobility window for the antibody/antigen complex expected. Thus, the signal at that point drops. Then, as antibody binds to analyte, the antibody migrates back to the pre-set window carrying the analyte and the concentration therefore increases until it reaches a maximum as all available complexes migrate to the same point. Different types of transient analysis are possible depending on the analyte and the antibody used. Different shapes of plot could be used to provide information on the local concentration of the various analytes and/or interactions between analytes.

### EXAMPLE 3

### Selective Assembly Concentration

In conventional electrophoresis, if the user is only interested in running a part of the sample, he still needs to run the entire separation. In the case of 2D Electrophoresis this means a one week run. On the contrary, with the present invention it is possible to set the field characteristics and the field parameter k to such values as to achieve separation of a pre-set mobility window. This allows for example to run a specific biomarker separation directly, without separating any molecules outside of the mobility window. This is an effective focusing action i.e. selective assembly concentration. The ability to run targeted mobility windows allows for application specific products.

FIG. 7 provides a demonstration of selective assembly concentration in the context of a binding assay. The left portion of FIG. 7 displays a typical field configuration (a simple linear field), where Emax=400 V/cm and Emin=0 V/cm.

The field is propagating with a speed V of 100 μm/s. Intermediate E values for each peak are displayed on the chart at 380, 300 and 200 V/cm. The peaks on the chart represent antigen bound antibody assembly (Ab+Antigen) and then dimer (Ab2) and monomer (Ab1) of the same antibody, respectively. These three groups of molecules have equilibrium field positions at 380, 300 and 200 V/cm, respectively (at that speed of field). This results in these molecules focusing/concentrating at those field points and therefore also separate in the medium accordingly.

The right portion of FIG. 7 shows the result of selective assembly concentration of the antibody/antigen complex. Using the software that controls the CycloChip, the Emin of the field is changed to 320 V/cm. This is very fast. The new field is now much flatter than before but the speed of the field remains the same (see right plot). As the field now varies between 320-400 V/cm the equilibrium position for the antibody/antigen complex is still within range of the field.

Therefore, the field still focuses around the same field point which now has moved spatially towards the right (this means in relative proportions to the edges of the field, since the point E=380 V/cm is actually moving with v=100 microns/s). However, the equilibrium points of the other two peaks (monomer and dimer) are now out of range therefore their equilibrium positions have vanished from the field of view. The other peaks will be attempting to find such positions but the equilibrium condition will never be satisfied so these molecules will not focus properly. This will effectively form some lumps and just contribute to the low background signal. This leaves only the peaks that have motilities compatible with the new field configuration to focus and concentrate (antibody/antigen complex). In this example this is just one peak, the antibody/antigen complex, but one can focus in and out of any number of peaks as desired.

The selective assembly concentration window can be extended to contain all Ab and Antigen in a ‘discovery mode’ or any subgroup of these peaks in ‘monitoring’ mode. Also one can change the electric field parameters in real time to change the selective assembly concentration position and window width. This can be done to simply focus around one peak, i.e. a particular antibody/antigen complex, or more than just one peak. In FIG. 2, the presented results are for a quite wide window that includes all peaks.

The selective assembly concentration action can be used as a selection or purification action to favour certain analytes over others. This is particularly useful for extracting analytes from the sample according to certain embodiments.

In other strategies selective assembly concentration can be used simply to make desired analytes separate better and move away from each other. This can be especially useful to separate, for example, isoforms or other groups of molecules which are variants of each other, to study for example glycosylation.

Thus, by the application of selective assembly concentration, an initial separation by electrophoresis becomes a very powerful tool to interrogate the contents of a sample in the electrophoresis medium without the need to subsequent extraction and processing steps.

### EXAMPLE 4

### Further Demonstrations of the Invention in Action

Further experimental runs were carried out to further demonstrate the power of the invention. FIG. 8 illustrates the results of several configurations run on different days using different running parameters with 4% linear polyacrylamide (LPA) as the sieving matrix (electrophoresis medium) and electric field speed at 0.04 cm/s (other conditions the same) to detect STAT5 with antibody as in FIG. 2. Dotted curves are Ab only, while the continuous curves are Ab+STAT5. As we can see in FIG. 8, again the STAT5 peaks are clearly distinguished from the Ab only runs. In this configuration, the STAT5 peaks were observed in approximately 120 seconds. This shows that the invention is capable of detecting antigen in less than 2 minutes. This surprising speed illustrates the utility of the invention as explained above.

I claim:

1. An electrophoresis method for detecting an analyte in a sample, the method comprising
providing the sample and an agent that specifically binds the analyte, combined in a fluid medium in a separation channel;
applying an electric field along the separation channel, the electric field having a field profile, and thereby causing bound and unbound analyte and/or agent to move relative to the fluid;
varying the applied electric field so as to adjust the field profile relative to the separation channel, thereby causing the bound analyte and the unbound analyte to concentrate at locations apart from one another in the fluid under the combined influences of an electric force due to the electric field and a hydrodynamic force due to the fluid.

2. The electrophoresis method according to claim 1, wherein the fluid medium is the sample.

3. The electrophoresis method according to claim 1, further including the step of detecting the analyte by its co-location with binding agent.

4. The electrophoresis method according to claim 1, wherein the sample and the agent are combined prior to contacting the fluid medium.

5. The electrophoresis method according to claim 1, wherein the sample is added to the separation channel pre-loaded with the fluid medium and binding agent.

6. The electrophoresis method according to claim 1, wherein the change in concentration of the analyte at a location is monitored over time, for example continuously or at defined time intervals.

7. The electrophoresis method according to claim 1, wherein the analyte comprises a biological cell or a biological molecule, such as a protein a nucleic acid or other biological polymer.

8. The electrophoresis method according to claim 1, wherein the agent comprises an antibody or antigen binding fragment thereof.

9. The electrophoresis method according to claim 1, wherein the agent is labelled with a detectable moiety.

10. The electrophoresis method according to claim 9, wherein the detectable moiety is a fluorescent molecule, an enzyme, a radioactive label, a DNA probe, or an electrochemiluminescent tag.

11. The electrophoresis method according to claim 1, wherein the sample is a sample of biological fluid.

12. The electrophoresis method according to any preceding claim 1, wherein the electric field varies with respect to the separation channel along at least a portion of the field profile, and/or wherein at least a portion of the electric field profile has a gradient which is non-zero.

13. The electrophoresis method according to claim 1, wherein the electric field is varied in such a way that the field profile moves relative to the separation channel, and, optionally, wherein the field profile remains otherwise unchanged as it moves relative to the separation channel.

14. The electrophoresis method according to claim 1, wherein the electric field is varied in such a way that the electric field profile translates along the separation channel.

15. The electrophoresis method according to claim 1, wherein the fluid and the separation channel are substantially stationary with respect to one another.

16. The electrophoresis method according to claim 1, wherein at least a portion of the electric field is monotonic with respect to distance along the channel.

17. The electrophoresis method according to claim 1, further comprising the step of modifying the electric field to: (i) adjust spacing between the unbound and bound analyte; (i) adjust the relative positioning of the unbound and bound analyte; (iii) adjust the resolution of signal of the unbound and bound analyte; (iv) adjust the intensity of signal from the unbound and bound analyte; and/or (v) adjust the concentration of the unbound and bound analyte at a particular location within the fluid.

18. The electrophoresis method according to claim 17, wherein the electric field is modified by changes to its time-dependence and/or its intensity.

19. The electrophoresis method according to claim 1, further comprising the step of extracting a sample of interest from the separation channel after the analyte and agent have located.

20-37. (canceled)

38. A diagnostic test comprising the method of claim 1.
